(19) United States
(12) Patent Application Publication
(10) Pub. No.: US 2012/0324346 A1
(43) Pub. Date: Dec. 20, 2012

(54) METHOD FOR RELATIONAL ANALYSIS OF PARSED INPUT FOR VISUAL MAPPING OF KNOWLEDGE INFORMATION

(76) Inventor: Terrence Monroe, Honolulu, HI (US)

(21) Appl. No.: 13/161,451

(22) Filed: Jun. 15, 2011

(51) Int. Cl. G06F 17/24

(52) U.S. Cl. 715/255

(57) ABSTRACT

A method for performing relational analysis of parsed input is employed to create a visual map of knowledge information. A title, header or subject line for an input item of information is parsed into syntactical components of at least a subject component and any predicate component(s) relationally linked as topic and subtopics. A search of indices for the knowledge map and its topics and subtopics is carried out for the subject component. If a match is found, then the subject component is taken as the existing topic. If no match is found, then the subject component is formatted as a new entry in the knowledge map. Topic-related information content is stored in the repository referenced to the formatted topic. A similar process can be carried out for formatting predicate component(s). In this manner, input items of information can be quickly and conveniently added to the knowledge information map.

### TECHNICAL FIELD

This invention generally relates to visual mapping of knowledge information, and particularly to performing relational analysis of parsed input for visual mapping of knowledge information.

### BACKGROUND

Knowledge created by human effort, research, and synthesis is constantly increasing. When people interact by communicating and exchanging information, the information shared between them will increase exponentially. With the vast and ongoing explosion of information within organizations of people of every kind, the task of capturing and sharing knowledge within an organization from volumes of shared information becomes increasingly difficult.

The field of knowledge management has been developed to develop frameworks for knowledge capture and sharing, and to employ strategies for managing knowledge processes within organizations. Explicit knowledge represents knowledge that is captured in a form that can easily be communicated to others. The creation or synthesis of “new knowledge” is continually being added to “established knowledge” captured and shared within a group, organization, or community. One strategy to managing knowledge encourages individuals to explicitly encode their knowledge into a shared knowledge repository, such as a knowledge database, so that they and others can retrieve knowledge provided to the repository. An important tool for encoding knowledge into and retrieving knowledge from a knowledge repository is knowledge mapping in which a visual representation (map) of knowledge objects in a repository is created so that users within a group, organization, or community can visually assess the contents of the repository and access desired content readily and quickly.

One example of a knowledge mapping system is the MindManager™ visual information mapping software offered by MindJet, Inc., having worldwide corporate headquarters located in San Francisco, Calif. The MindManager™ software enables a user to create, add to, and use a knowledge map created for a given theme or subject. A knowledge map is created and expanded by entering labels for topics, subtopics, sub-subtopics, etc., each of which represents a container (file, folder, or repository object) for storing information content related to that label. The relatedness of each topical label to one or more other topical labels is also defined, resulting in a tree or network structure that can be added to, expanded, modified, and re-organized in an intuitive manner using visual click-and-drop tools. Other trees or networks of knowledge containers can be linked and managed in a similar manner. The knowledge mapping is intended to bring visual order to ideas and information by displaying all related topical objects on a requested subject into a single interactive view. A wide range of types of information content, attachments, notes, links, etc., can be stored in a container and viewed using an integrated viewer. Knowledge content can then be visually accessed, acted upon, and/or exported to other applications.

However, presently available knowledge mapping tools lack a convenient way to quickly or even automatically define a topic to be added and/or its relationship to other topics in a knowledge tree or network. They further lack a convenient way to quickly or automatically add information content to an already defined topic and/or its links to other information content in that or other topics in the knowledge tree or network.

### SUMMARY OF INVENTION

In accordance with a preferred embodiment of the present invention, a method for relational analysis of an input item of information having a title, header or subject line and content to which it refers, said method to be performed on a computer system operating a visual knowledge mapping software program for creating a visual map of input information items related to a given theme and to each other as topics and subtopics in order to create a visual map of knowledge information of the given theme, and said computer system having a storage repository for storing information content of topic and subtopics referenced on the visual map of knowledge information, said method comprising:

Parsing a title, header, or subject line for an input item of information into syntactical components of at least a subject component and any predicate component syntactically related thereto;

Determining the subject component as a topic and any predicate component as a subtopic relationally linked thereto;

Searching an index of any existing knowledge information map and any existing topics and subtopics created therein for a match to said subject component syntactically parsed from the input item of information;

If a match to an existing topic is found, then formatting said subject component to be the same as the existing topic, and if no match is found, then formatting said subject component as a new topic in the existing knowledge information map, and

Storing any topic-related information content of the input item of information in the storage repository of the computer system referenced to the formatted topic on the visual map of knowledge information,

Whereby input items of information can be quickly and conveniently added to the knowledge information map created and maintained on the computer system.

In the preferred embodiment, further steps of the method may be carried out for any predicate component by:

Searching the index of the existing knowledge information map and existing subtopics created therein for a match to said predicate component syntactically parsed from the input item of information;

If a match to an existing subtopic is found, then formatting said predicate component to be the same as the existing subtopic, and if no match is found, then formatting said predicate component as a new subtopic in the existing knowledge information map; and

Storing any subtopic-related information content of the input item of information in the storage repository of the computer system referenced to the formatted subtopic on the visual map of knowledge information.

A particularly useful application for the method of the present invention is for creating knowledge maps of educational subjects for teaching. Knowledge maps for History, for example, can be formatted according to region (Asia, America, Europe, etc.), chronological order (ancient times to present day), thematically (women's movement, organized labor, occupations of conquered lands, etc.). From a “master map” for the History theme of instruction, a student learner can access individual knowledge maps, for example, for the history of philosophy, the history of art, the history of law, the history of science and technology, or the history of medicine.

Other objects, features, and advantages of the various embodiments of the present invention will be explained in the following detailed description with reference to the appended drawings.

### BRIEF DESCRIPTION OF DRAWINGS

FIG. 1 is a flow diagram illustrating an overall architecture for relational analysis of semantically parsed input for visual mapping of knowledge information in accordance with a preferred embodiment of the present invention.

FIG. 2 illustrates an example of the Scan-to-Map process for scanning an input item of information and formatting its semantic elements into a new knowledge map.

FIG. 3 illustrates searching a root directory of knowledge maps for a match to a scanned subject of the input item of information.

FIG. 4 illustrates a close-up of the root directory of knowledge maps in FIG. 3.

FIG. 5 illustrates expansion of a knowledge map showing various aspects of relational schema (“Why”, “How”, “So”, “Meaning”, “Analogy”, and “Concept”).

FIG. 6 illustrates another portion of the expanded knowledge map in FIG. 5.

FIG. 7 illustrates a portion of an expanded knowledge map showing links to multimedia websites, image galleries, videos, articles, etc.

### DETAILED DESCRIPTION

In the following detailed description, certain preferred embodiments are described as illustrations of the invention in a specific application, network, or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

Some portions of the detailed description which follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Aspects of the present invention, described below, are discussed in terms of steps executed on a computer system, which may be one of any type having suitable computing resources. Aspects of the present invention are also discussed with respect to an Internet system including electronic devices and servers coupled together within the Internet platform, but it may be similarly implemented on any other type of extended network system including wireless data or digital phone networks. Although a variety of different computer systems can be used with the present invention, an exemplary computer system is shown and described in a preferred embodiment of the present invention system.

In the preferred embodiment, a relational analysis of new items of information is performed to determine their relationships to existing topics and/or items of information content already captured in a visual knowledge map. A commercially available knowledge mapping tool is used to create and maintain a visual knowledge map. An example of a preferred knowledge mapping system for use in the present invention system is the MindManager™ visual information mapping software offered by MindJet, Inc., in San Francisco, Calif. (as described previously).

The present system is predicated on the premise that all knowledge is in some way interconnected. As such, it operates by performing a relational analysis of an input item of information to determine its topical definition and relationships to existing items of information already mapped into a knowledge repository. In general, each input item of information will have a title, header or subject line and information content to which it refers. The relational analysis process is initiated by executing a parsing of the title, header or subject line. The title, header or subject line is scanned and broken down into one or more syntactical components of at least a subject and perhaps one or more predicates. The syntactical components are then analyzed to determine their relationships to existing topics and subtopics already captured in the knowledge map. If the input item is a new topic relevant to the knowledge map, then a new topical label is added to the knowledge map and any topic-related information content is stored in the repository indexed by that topical label. If the input item is identified with an existing topic already in the knowledge map, then it is formatted the same as the matching topical label and any information content is added to the repository referenced by that topical label. A similar process can be carried out for formatting any predicate(s) syntactically parsed from the input item of information. The complete process of parsing of input, relational analysis of syntactical components, and addition to knowledge map is referred to herein as the “Scan-to-Map” process.

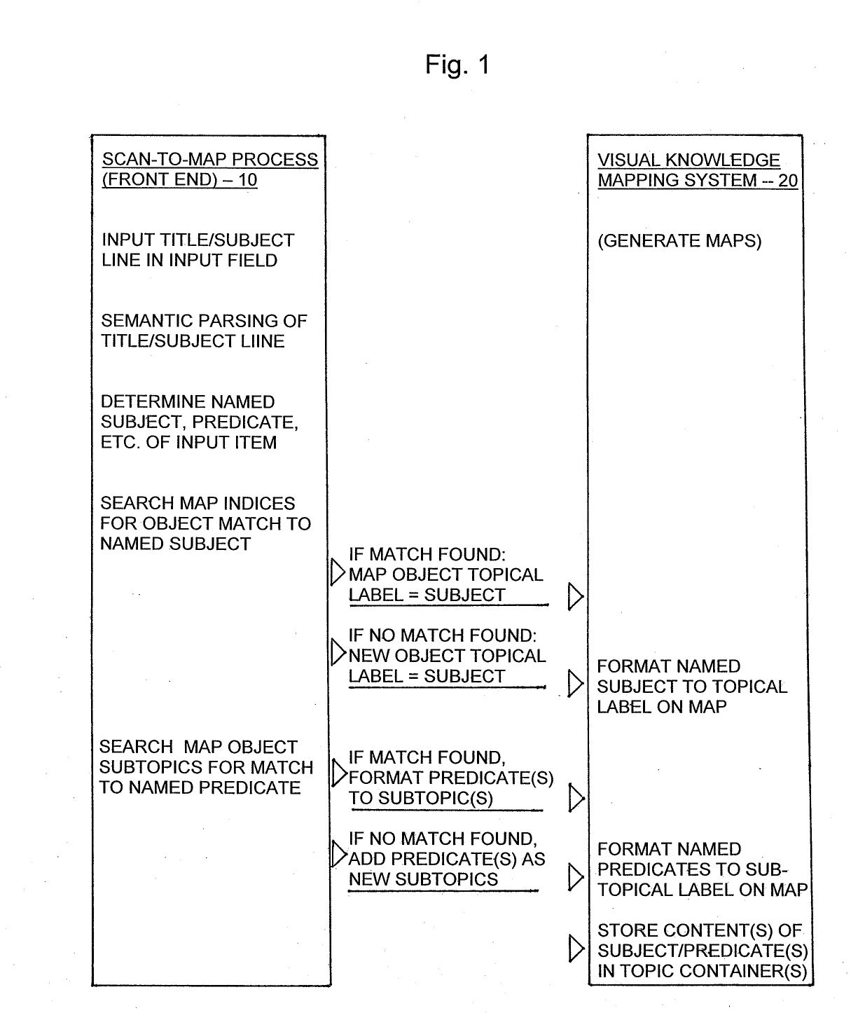

Referring to FIG. 1, a preferred embodiment for the Scan-to-Map method in the present invention is illustrated showing its performing of relational analysis of parsed input items of information to a visual map of knowledge information. The Scan-to-Map process 10 is configured as an input front end to a Visual Knowledge Mapping System 20. The Scan-to-Map process first scans the text of the title, header or subject line of an input item of information. The text sentence or phrase is broken down into subject(s), predicate(s), and other syntactical components. The syntactical functions of the parsed components are then determined. Their syntactical functions determine the type of object that it will be formatted as in the knowledge map. A “subject” syntactically parsed from the title sentence or phrase will be defined as a “parent” knowledge object, typically a topic on the knowledge map. One or more predicates in the syntax of the title sentence or phrase will be defined as “offspring” knowledge objects, typically subtopics on the knowledge map. The formatting of “parent” and “offspring” objects is then carried into the knowledge map.

In natural language processing systems, human languages are parsed by parser programs of varying levels of semantic depth and complexity. Human sentences are not easily parsed by computer programs, as there is substantial ambiguity in the structure of human language. Some parsing systems use lexical functional grammar, while others may use a more complex “head-driven phrase structure” grammar. Shallow parsing programs aim to find only the boundaries of major constituents such as noun phrases. Another popular strategy for avoiding linguistic complexity is dependency grammar parsing. Most modern parsers are at least partly statistical, that is, they rely on a corpus of training data which has already been annotated (parsed manually). This approach allows the system to gather information about the frequency with which various semantic constructions occur in specific contexts. A widely used application for semantic parsers of relatively low complexity is as a spelling and grammar checker for word processing programs. For example, commercially available, semantic parser programs for word processing in English and other languages are offered by Babylon.com, based in San Francisco, Calif.

The parser generator deconstructs a sentence or phrase of scanned text and identifies its syntactical elements. Phrase-structure rules can be used to break down a natural language sentence or phrase into constituent parts. The parser generator program can associate executable code with each of these grammatical rules, sometimes referred to as “semantic action routines”. These routines may construct a parse tree (or abstract syntax tree), or generate executable code directly. The resulting elements in a parse tree can be converted to knowledge map schema utilizing a markup tag (such as in XML tagging). The tagged elements can then be associated with analogous parent/offspring knowledge objects in the knowledge map. These knowledge objects are then associated with other objects in the knowledge map in a relational format that reflects their semantic levels of function. An example of relational links that may be used to reflect semantic level of function are those corresponding to semantic functions of “Why”, “How”, “So”, “Meaning”, “Analogy”, and “Concept”. The relational links may be determined by relational rules automatically or ascertained through human analysis to be incorporated manually.

For formatting in a knowledge map, the parsed objects may be associated with existing knowledge objects in a relational schema, using relational links labeled “Why” (to explicate a knowledge object's reasons); “How” (to explicate a knowledge object that represents a process); and “So” (to explicate a knowledge object's effect, result, or outcome). The program determines whether a sentence element has such a relationship (as a “Why”, “How”, or “So” offspring) according to grammatical rules as to a) the order in which the sentence element appears; b) the structure in which it occurs; c) the type of meaning it expresses; d) the type of affixes it takes; e) Boolean predicates that the content must satisfy; f) data types governing the content of elements and attributes, and g) more specialized rules such as uniqueness and referential integrity constraints.

The relational formatting process also uses relational links labeled “Meaning” (to explicate the significance of a knowledge object) and “Analogy” (to establish a relationship of a knowledge object to an analogous knowledge object elsewhere—useful in comparing comparable events in history). These relationships are ascertained through human analysis, and are incorporated into the knowledge map manually. New input is mapped either by creating a new knowledge map for a subject or by incorporating it into an existing map.

The relational link “Concept” is used to establish a social, cultural, religious, political, economic, behavioral or other concept that relates to a topic in the map to which it is appended, and to comparable topics in other maps.

The program searches for the named subject in an index of existing knowledge objects. If a match is found for the named subject, the program determines what the various secondary predicates in the scanned text are and correspondingly appends these secondary objects to the pre-existing map as offspring objects. If no match is found, the program would regard the new input as a new subject, and create a new knowledge map for that subject.

The parsed elements can be automatically formatted into an existing knowledge map by checking them against existing indices maintained in a system, in the following order:

1. Root directory of knowledge maps, with links to listed subsidiary maps.

2. Specific knowledge map with name of subject, with links to listed topics

3. Specific topics with name of subject, with links to listed subtopics

4. Specific subtopics with name of subject, with links to listed sub-subtopics

5. Etc., to lowest level of relational hierarchy in specific knowledge map

If no existing knowledge object is found in the system indices matching the named subject, the formatting procedure can automatically format the named subject by determining its relational link to an existing object in the knowledge map. The automatic formatting can be performed by finding the object at the highest level of relational hierarchy for which the named subject matches that object's semantic function of “Why”, “How”, “So”, “Meaning”, “Analogy”, and “Concept”, and incorporating the named subject as a subtopic to that object. Alternatively, the named subject can be manually defined as the label for a topic in the appropriate knowledge map, and its relational links to existing objects can also be manually defined. In a similar manner, the named predicates and sub-predicates to the named subject can be quickly or even automatically defined relationally with respect to existing subtopics of the determined topical object.

If the input item of information has a header of multiple sentences, such as an abstract for an article as information content, then a corpus-based parsing strategy may be used. For example, a “subject” may be identified from a keyword appearing most frequently in the text, and any predicates can be identified from predicate syntactical components referenced by the identified subject keyword.

While the primary purpose of the invention method is to enable the parsing, relational analysis, and formatting of input items of information to be done automatically for speed, efficiency, and convenience, the option for manual intervention of an expert in the subject theme for knowledge map creation may also be included. Conceptual or semantic mapping, which explicates the significance of meaning and relationship among knowledge objects, may be performed manually, using the specialized expertise of a map creator in the subject who comprehends the significance of various aspects of that subject and of their inter-relationships and relationships to other subjects.

Using the Scan-to-Map process, input items of information can be quickly or automatically added and properly formatted into a knowledge map maintained by the system. Input items of information from a wide range of sources can thus be conveniently added to a knowledge map, such as links to relevant webpages, email text and/or attachments, links from annotated text, articles, blogs, etc. The Scan-to-Map process would enable such new items to be quickly or automatically added to a knowledge map simply by clicking and dropping the URL address, email header, or annotated link into the input field for the knowledge map.

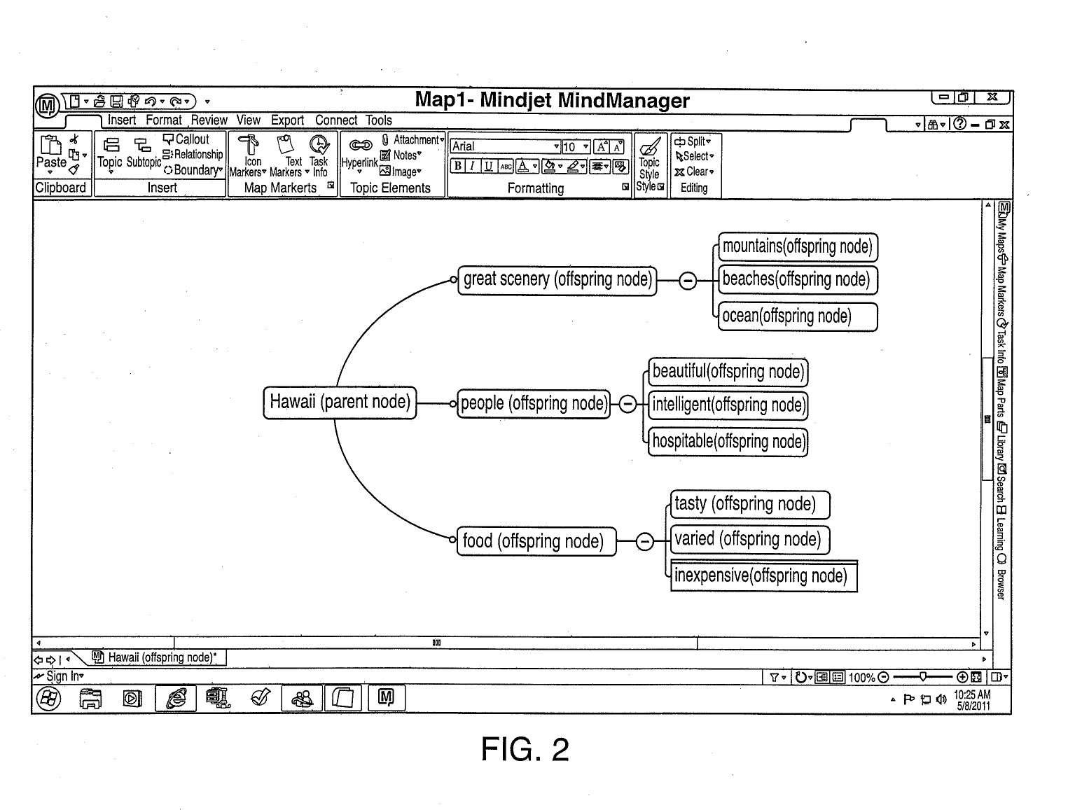

FIG. 2 illustrates an example of the Scan-to-Map process for scanning an input item of information and formatting its semantic elements into a new knowledge map. In this example, the title or subject line sentence is scanned as text: “Hawaii has great scenery of mountains, beaches, and ocean, people who are beautiful, intelligent, and hospitable, and food that is tasty, varied, and inexpensive.” Once this sentence is scanned, it is broken down into its subject, i.e., “Hawaii”, predicates, i.e., “great scenery, people, food”, and corresponding sub-predicates, and relationally formatted into the knowledge map as parent and offspring (and further offspring) nodes.

The formatting of predicates as subtopics can also be carried out automatically. Consider the input sentence, “Hawaii has good weather, friendly people, and tasty food.” The system can parse the input sentence in the Scan-to-Map function and identify a predicate (“good weather”). A search of the topic indices reveals that under the subject “Hawaii” there is no subtopic “good weather.” The system will then format the predicate “good weather” to be a sub-topic of “Hawaii” and creates an entry in the map for this new sub-topic/predicate, and links this entry to the parent “Hawaii” entry as an offspring object. All of the sub-predicates that relate to “good weather” (e.g., “blue skies”, “warm temperatures”, and “fluffy white clouds”) may similarly be considered sub-topics.

Every predicate becomes an identified syntactical object when a sentence is broken down. Whether it is stored as content of a parent object or formatted separately as an offspring object depends on how much material it presents. For example, when a topic presents more information than can be viewed as an extension on the map or otherwise viewed without scrolling, the Scan-to-Map function can create new sub-topic offspring objects that are linked to the parent object.

The Scan-to-Map program can determine whether to assign material to an existing topic on a higher level—or set it up as a new map—by the context of the information scanned. For example, if a scanned article is determined (by the preponderance of subject words) to be concerned primarily with the subject “Hawaii”, then a sub-topic “good weather” can be assumed to relate to the parent heading “Hawaii” rather than to another parent, say, “Florida.” If no topical match to “Hawaii” is found, the subject can be considered to be a new parent object, distinct from all other parent subjects, and is placed in the index in alphabetical order of parent subjects.

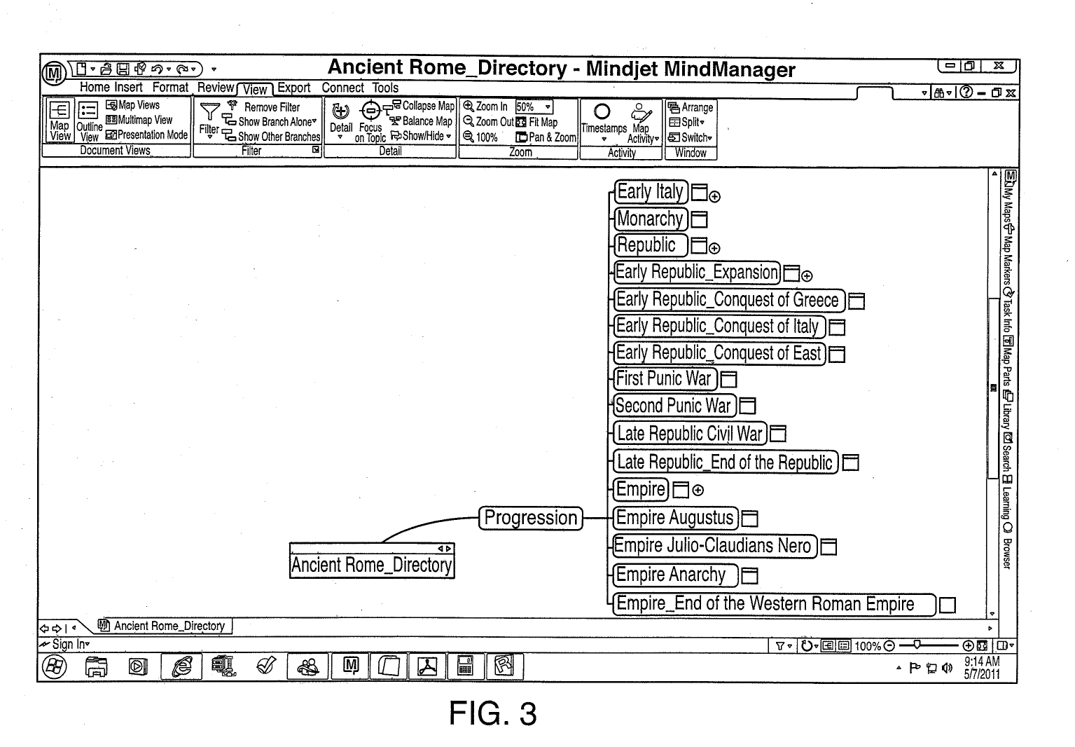

FIG. 3 illustrates searching a root directory of knowledge maps for a match to a scanned subject of the input item of information.

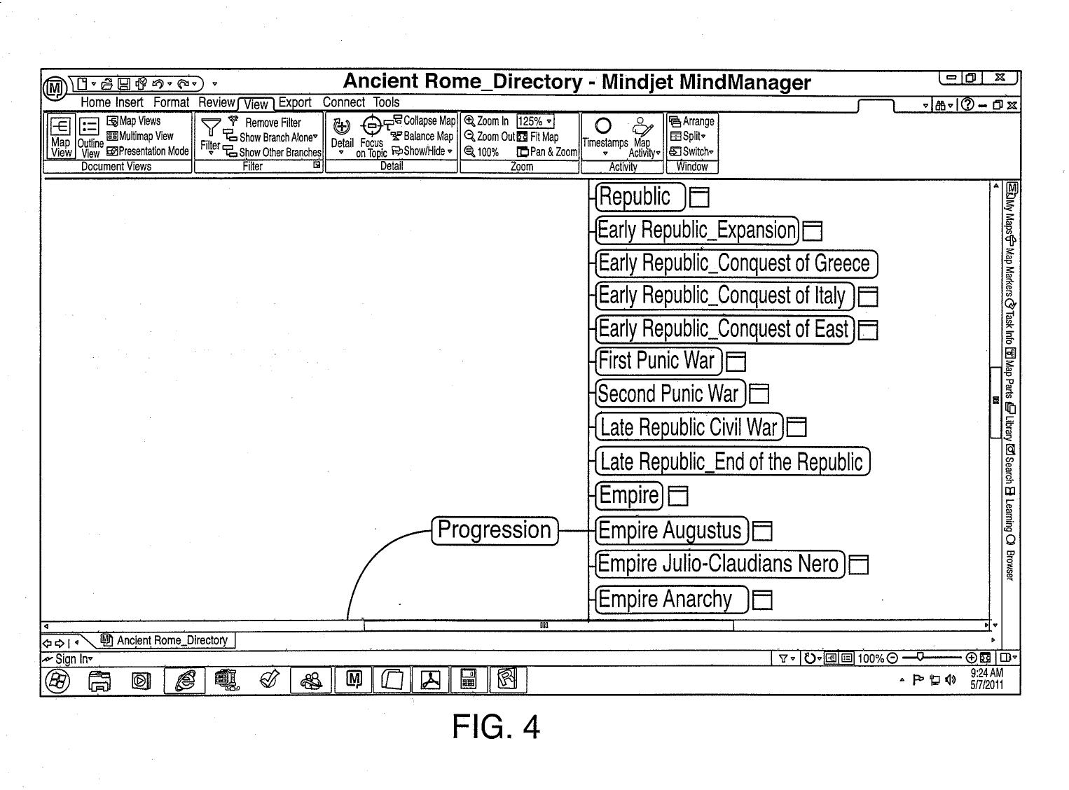

FIG. 4 illustrates a close-up of the root directory of knowledge maps in FIG. 3.

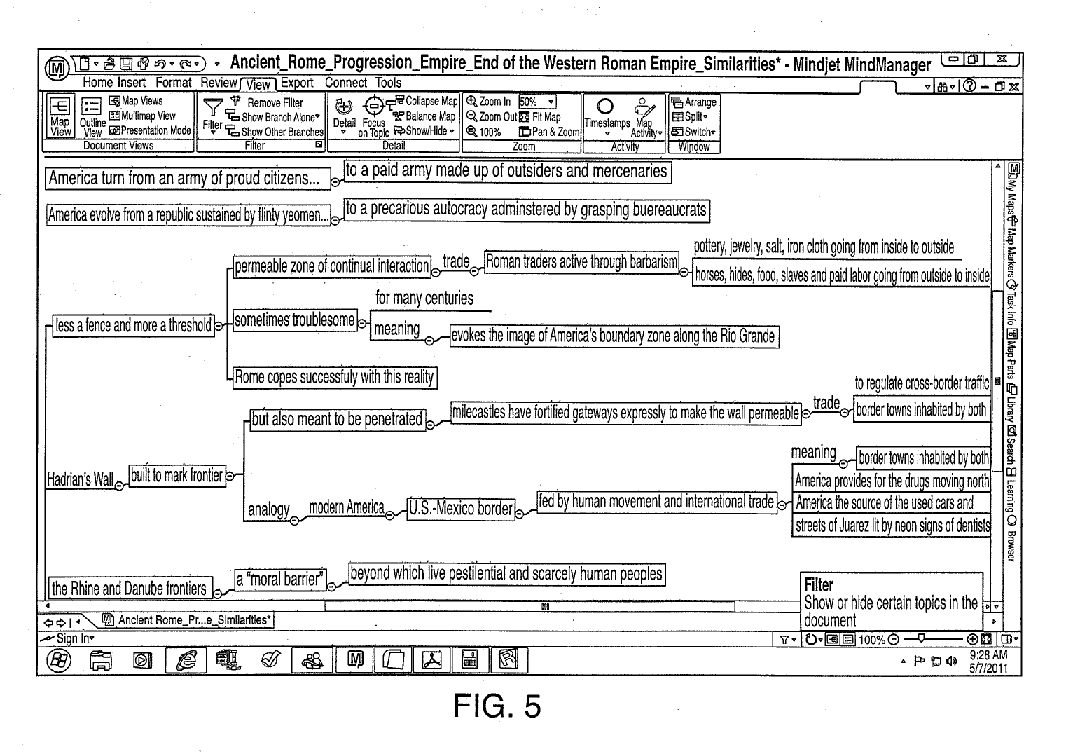

FIG. 5 illustrates expansion of a knowledge map showing various aspects of relational schema (“Why”, “How”, “So”, “Meaning”, “Analogy”, and “Concept”).

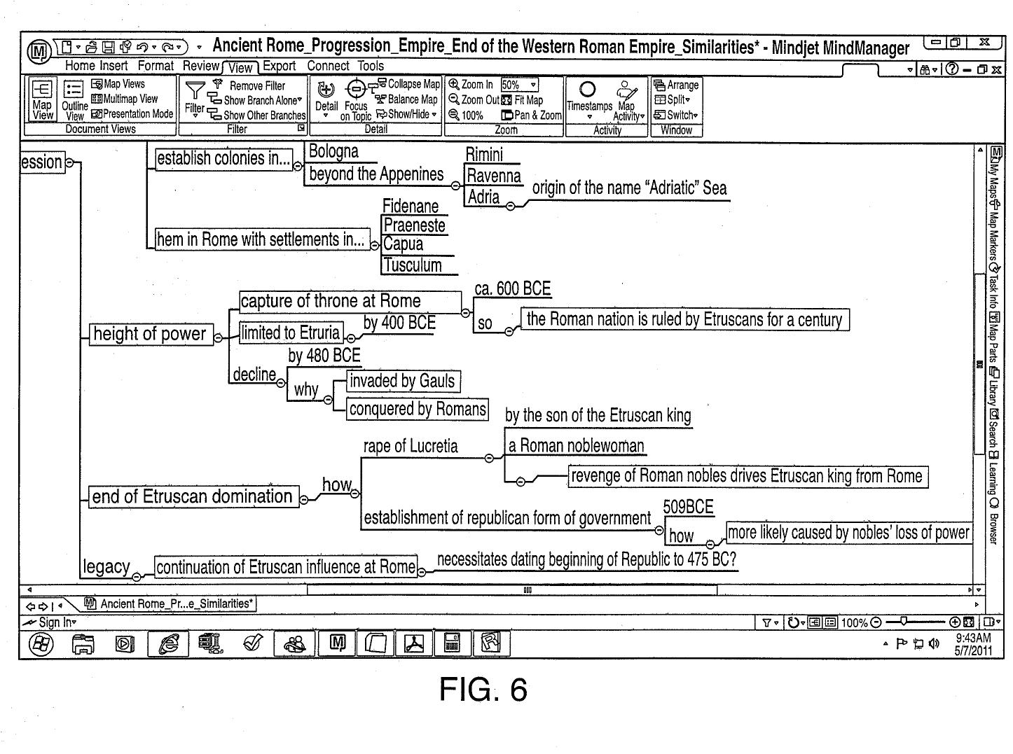

FIG. 6 illustrates another portion of the expanded knowledge map in FIG. 5.

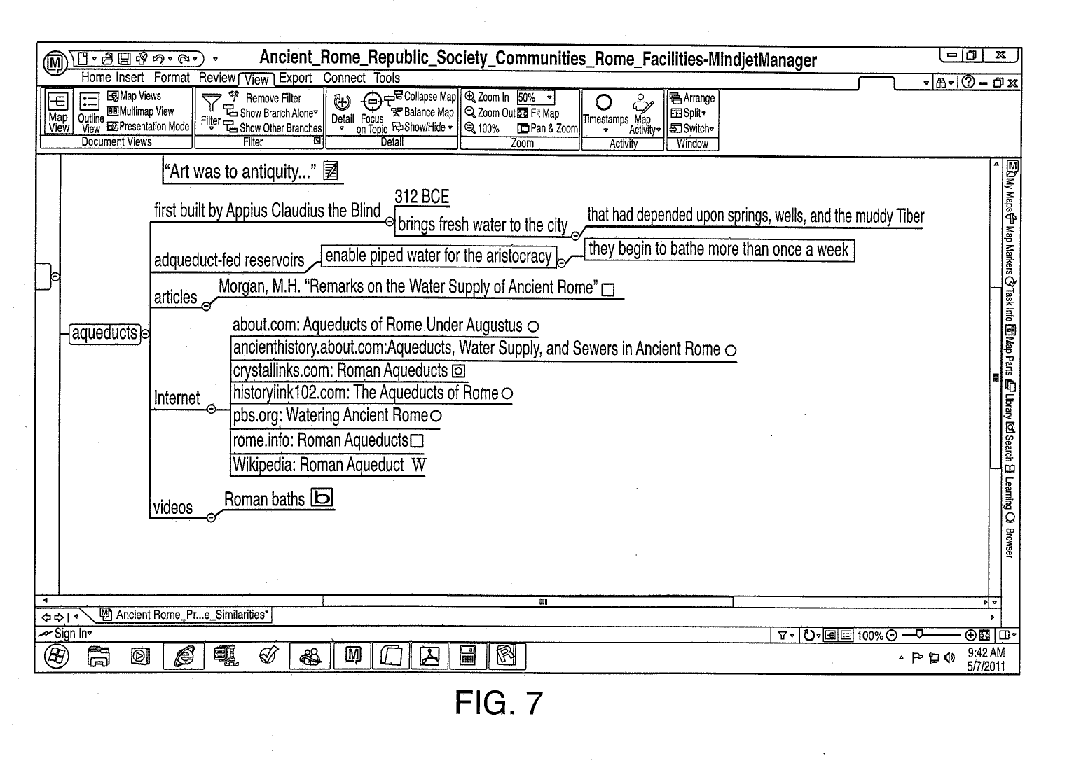

FIG. 7 illustrates a portion of an expanded knowledge map showing links to multimedia websites, image galleries, videos, articles, etc.

A particularly useful application for the method of the present invention is for creating knowledge maps of educational subjects for teaching. Knowledge maps for History, for example, can be formatted according to region (Asia, America, Europe, etc.), chronological order (ancient times to present day), thematically (women's movement, organized labor, occupations of conquered lands, etc.). From a “master map” for the History theme of instruction, a student learner can access individual knowledge maps, for example, for the history of philosophy, the history of art, the history of law, the history of science and technology, or the history of medicine.

The knowledge-mapped instructional system can be used to deliver an entire curriculum of arts and sciences, law, and business courses, so that the learner can acquire in this fashion nearly all subjects taught in high school, college, graduate school, vocational school, corporate and government training programs, and elsewhere.

Once developed, the knowledge maps may be used in different ways. They can be used to analyze a subject on a stand-alone basis, or as a medium for instruction in a particular discipline. This can be done by aggregating and organizing a particular subject's maps in an ordered course of instruction. An online instructional environment in which this takes place is a “course management system” that can include:

a) Lessons sections which contain respective knowledge maps for instruction;

b) Discussion/analysis workspaces related to the knowledge maps;

c) Features sections such as: an Announcements forum; a Course Calendar; a Collaboration workspace with a Virtual Classroom and Live Chat facility; a Course Roster, and more;

d) Mail section for email among users;

e) Course Information section that includes a course syllabus, system instructions, help files, and links to Technical Support;

f) Comprehensive Assessment Profile (CAP) to generate and maintain records of assessment scores and overall learner progress in a course, number of academic areas, or overall transcript.

Refinements to the instructional system can include the embedding or integration of a map of a given subject (philosophy, for example) in another, broader map (history, perhaps). In this case, the philosophy map can be highlighted in a distinctive color as it displays in the context of the broader history map that it is embedded in. This provides the learner with a context that, in this case, explicates the development of philosophy as it occurs in the historical process. This enables the user to understand a subject from different perspectives, and to understand how the subject's knowledge objects relate to knowledge objects in other subjects.

The knowledge-mapped instructional system can incorporate extensive multimedia into its formatting. Many of the knowledge objects in a map may be links to websites, bibliographies, articles and books, primary sources, films and videos, symphonies and other audio files, interactive maps, museum exhibits, lectures, and more. They can also link to discussion/analysis forums, chat rooms, assessment tools, and indexes that are keyed to specific topics in the map.

The Comprehensive Assessment Profile (CAP) is an important part of the knowledge-mapped instructional system. The assessments are coordinated with the maps used for instruction and used to objectively measure the learner's progress and provide a next-generation report card. The assessments can be embedded in the knowledge maps at appropriate points in the learner's progression through the curriculum of maps, so as to provide a measure of the learner's progress through specific aspects of the subject. The CAP can record percentile scores associated with assessment on specific aspects of a course. In this way, the CAP can provide insight into specific areas of a learner's strength and weakness in various topical areas and for an overall course. The CAP can provide component and aggregate scores, rather than assigning a traditional letter grade to the overall course of instruction. This removes the subjective factors in grading (such as teacher favoritism and student pressure on the instructor) that result in grade inflation and loss of credibility of the credential.

Many modifications and variations may of course be devised given the above description of the principles of the invention. It is intended that all such modifications and variations be considered as within the spirit and scope of this invention, as defined in the following claims.

1. A method for relational analysis of input items of information, each having a title, header or subject line and content to which it refers, said method to be performed on a computer system operable with a visual mapping software program for creating a visual map of input items of knowledge information related to a given theme and to each other as topics and subtopics in order to create a visual map of knowledge information of the given theme, said computer system including a storage repository for storing information content related to the given theme for topic and subtopics referenced on the visual map of knowledge information, said method comprising:
a) parsing a title, header, or subject line for an input item of information into syntactical components of at least a subject component and any predicate component syntactically related thereto;
b) determining the subject component as a topic and any predicate component as a subtopic relationally linked thereto;
c) formatting the determined subject-predicate components' syntactical relationship into a display of a topic-subtopic relational linking on the knowledge information map, including searching a topic-subtopic index of the knowledge information map for any existing topics or subtopics created therein for a match to said subject component syntactically parsed from the input item of information;
d) if a match to an existing topic or subtopic is found, then formatting said subject component to be displayed the same as the existing topic or subtopic, and if no match is found, then formatting said subject component to be displayed as a new topic in the existing knowledge information map, and also formatting said predicate component to be displayed as a subtopic of the displayed topic,
whereby input items of information can be quickly and conveniently added to the knowledge information map to be created and maintained on the computer system.

2. A method according to claim 1, further comprising:
a) searching the index of the existing knowledge information map and existing subtopics created therein for a match to said predicate component syntactically parsed from the input item of information; and
b) if a match to an existing subtopic is found, then formatting said predicate component to be the same as the existing subtopic, and if no match is found, then formatting said predicate component as a new subtopic in the existing knowledge information map.

3. A method according to claim 1, further comprising storing topic-related information content of the input item of information in the storage repository of the computer system referenced to its formatted topic on the visual map of knowledge information.

4. A method according to claim 2, further comprising storing subtopic-related information content of the input item of information in the storage repository of the computer system referenced to the formatted subtopic on the visual map of knowledge information.

5. A method according to claim 1, wherein parsed input components are automatically formatted into an existing knowledge map by checking them against indices of topics and subtopics maintained by the computer system.

6. A method according to claim 5, wherein the parsed input components are checked against a hierarchy of indices in the following order:
a) root directory of knowledge maps, with links to listed subsidiary maps;
b) specific knowledge map with name of subject, with links to listed topics;
c) specific topics with name of subject, with links to listed subtopics; and
d) specific subtopics with name of subject, with links to listed sub-subtopics.

7. A method according to claim 1, wherein a knowledge map is created and maintained for an educational subject for teaching.

8. A method according to claim 7, wherein the knowledge map is used on a stand-alone computer.

9. A method according to claim 7, wherein the knowledge map is used on an online network as a medium for online instruction in the educational subject.

10. A method according to claim 9, wherein a plurality of knowledge maps are aggregated and organized in an ordered course of instruction.

11. A method according to claim 10, wherein the ordered course of instruction is managed by a course management system.

12. A method according to claim 11, wherein the course management system includes one or more functional components from the group consisting of: a) lesson section which contain respective knowledge maps for instruction; b) discussion and analysis workspace related to the knowledge maps; c) an Announcements forum; d) a Course Calendar; e) a Collaboration workspace; f) a Course Roster; g) a mail section for communication among users; and h) course information section.

13. A method according to claim 11, wherein the course management system includes a Comprehensive Assessment Profile (CAP) section to generate and maintain records of assessment scores and overall learner progress.

14. A method according to claim 11, wherein the course management system includes multimedia knowledge objects with links to information content such as websites, bibliographies, articles and books, primary sources, films and videos, symphonies and other audio files, interactive maps, museum exhibits, and online lectures.

15. A method according to claim 13, wherein the Comprehensive Assessment Profile (CAP) section includes assessments that are coordinated with knowledge maps used for instruction and used to objectively measure a learner's progress via an online report card.

16. A method according to claim 1, wherein said parsing of a title, header, or subject line for an input item of information includes deconstructing a sentence or phrase of scanned text and identifying its syntactical elements using phrase-structure rules to break down a natural language sentence or phrase into constituent elements, and tagging the constituent elements as corresponding knowledge map schema to be displayed as analogous parent/offspring knowledge objects in the knowledge map.

17. A method according to claim 16, wherein the knowledge map schema include those corresponding to a semantic function of the group consisting of: “Why”, “How”, “So”, “Meaning”, “Analogy”, and “Concept”.

18. A method according to claim 17, wherein the semantic function of a sentence element is determined according to one or more grammatical rules of the group consisting of: (a) the order in which the sentence element appears; (b) the structure in which it occurs; (c) the type of meaning it expresses; (d) the type of affixes it takes; (e) Boolean predicates that the content must satisfy; (f) data types governing the content of elements and attributes, and (g) more specialized rules such as uniqueness and referential integrity constraints.
